(19) United States
(12) Patent Application Publication
(10) Pub. No.: US 2016/0146204 A1
(43) Pub. Date: May 26, 2016

(54) PLUNGER APPARATUS FOR HIGH PRESSURE PUMP

(71) Applicant: Hyundai Motor Company, Seoul (KR)

(72) Inventor: Jung Hwan HAN, Ansan-si (KR)

(21) Appl. No.: 14/683,969

(22) Filed: Apr. 10, 2015

(30) Foreign Application Priority Data
Nov. 25, 2014 (KR) 10-2014-0165150

(51) Int. Cl. F04B 53/14; F04B 53/16; F02M 59/46; F04B 17/04; F02M 59/10; F02M 59/02

(52) U.S. Cl. CPC F04B 53/146; F02M 59/10; F02M 59/025; F02M 59/462; F04B 17/04; F04B 53/16

(57) ABSTRACT

A plunger apparatus for a high pressure pump includes a plunger having a quadrangular cross section and reciprocating in an internal passage provided in a housing to deliver a low pressure fluid to a compression chamber. A guide is connected to the plunger to guide the plunger when the plunger reciprocates.

### CROSS REFERENCE TO RELATED APPLICATION

The present application claims the benefit of priority to Korean Patent Application No. 10-2014-0165150, filed Nov. 25, 2014, the entire contents of which is incorporated herein for all purposes by this reference.

### TECHNICAL FIELD

The present disclosure relates to a plunger apparatus for a high pressure pump, and more particularly, to a plunger apparatus for a high pressure pump capable of preventing a plunger for a high pressure pump for a liquefied petroleum gas (LPG) direct injection (LPDI) engine from being immovable within a housing.

### BACKGROUND

A high pressure pump of an LPDI vehicle includes a plunger for delivering a fuel from a low pressure pump to a compression chamber. When a controller sends a signal to a solenoid, the plunger opens a valve by a magnetic field of the solenoid to deliver the fuel from the low pressure pump to the compression chamber.

FIG. 5 is a view illustrating a plunger apparatus for a high pressure pump according to the related art, and FIG. 6 is a cross-sectional view taken along the line C-C of FIG. 5 and illustrates that a plunger 50 has a circle shape. A plunger 50 reciprocates in an internal passage 11 of a housing 10 and may reciprocate by a micro gap 13 formed between an inner peripheral surface of the internal passage 11 and an outer peripheral surface of the plunger 50.

However, due to characteristics of LPG fuel, a phase change (liquid→gas) suddenly occurs due to a temperature change, such that tar in the fuel may be accumulated in the micro gap 13. The tar is sticky due to high viscosity, and therefore, when the tar is stuck between the internal passage 11 of the housing 10 and the plunger 50, the plunger 50 is stuck and thus is not operated, thereby deteriorating quality of the pump.

Therefore, a need exists for a plunger apparatus for a high pressure pump in which a plunger smoothly reciprocates even though tar is generated due to a phase change of fuel and is thus accumulated between an internal passage and a housing to prevent quality from deteriorating.

The matters described as the related art have been provided only for assisting in the understanding for the background of the present disclosure and should not be considered as corresponding to the related art known to those skilled in the art.

### SUMMARY

An aspect of the present inventive concept provides a plunger apparatus for a high pressure pump in which a plunger smoothly reciprocates to prevent quality from deteriorating even though tar is generated due to a phase change of a fuel and is thus accumulated between an internal passage and a housing.

According to an exemplary embodiment of the present invention, a plunger apparatus for a high pressure pump includes a plunger having a quadrangular cross section and reciprocating in an internal passage provided in a housing to deliver a low pressure fluid to a compression chamber. A guide is connected to the plunger to guide the plunger when the plunger reciprocates.

The plunger may have a square pillar shape.

An inner peripheral surface of the internal passage may have a circular shape. The plunger may have rounded corners which correspond to the inner peripheral surface of the internal passage.

The plunger may have a through hole at the center thereof in a reciprocating direction. The guide may penetrate through the through hole to guide the plunger when the plunger reciprocates linearly.

A space may be formed between an outer peripheral surface of the plunger and the internal passage, and the fluid may move through the space.

### BRIEF DESCRIPTION OF THE DRAWINGS

The above and other objects, features and advantages of the present disclosure will be more clearly understood from the following detailed description taken in conjunction with the accompanying drawings.

FIG. 1 is a view illustrating a high pressure pump according to an exemplary embodiment of the present inventive concept.

FIG. 2 is a cross-sectional view taken along the line A-A of FIG. 1.

FIG. 3 is a view illustrating a plunger apparatus for a high pressure pump according to an exemplary embodiment of the present inventive concept.

FIG. 4 is a cross-sectional view taken along the line B-B of FIG. 3.

FIG. 5 is a view illustrating a plunger apparatus for a high pressure pump according to the related art.

FIG. 6 is a cross-sectional view taken along the line C-C of FIG. 5.

### DETAILED DESCRIPTION

Hereinafter, a plunger apparatus for a high pressure pump according to exemplary embodiments of the present inventive concept will be described with reference to the accompanying drawings.

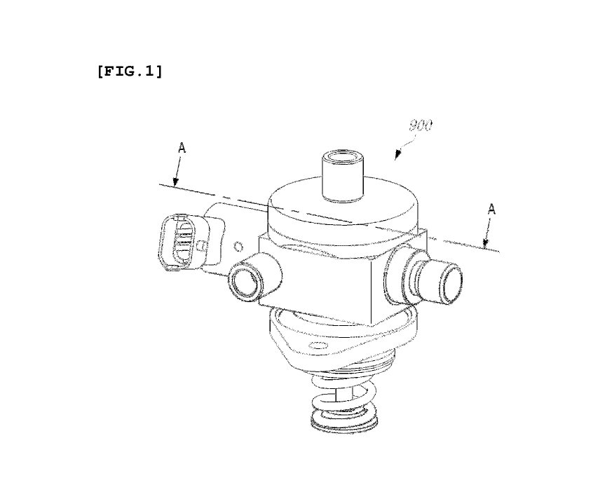

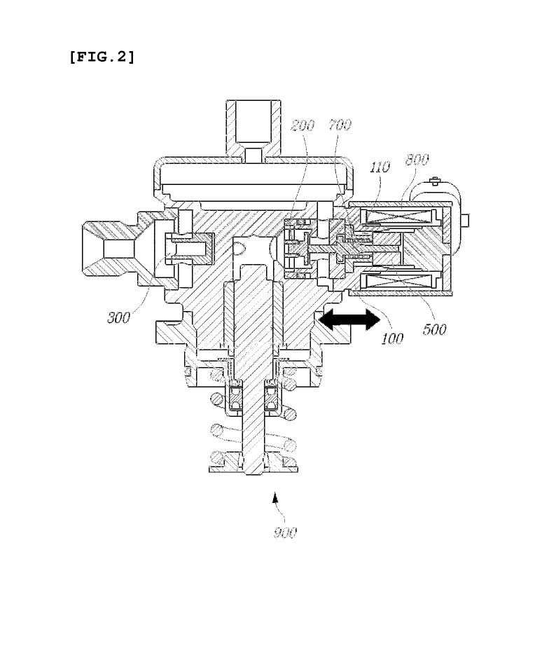

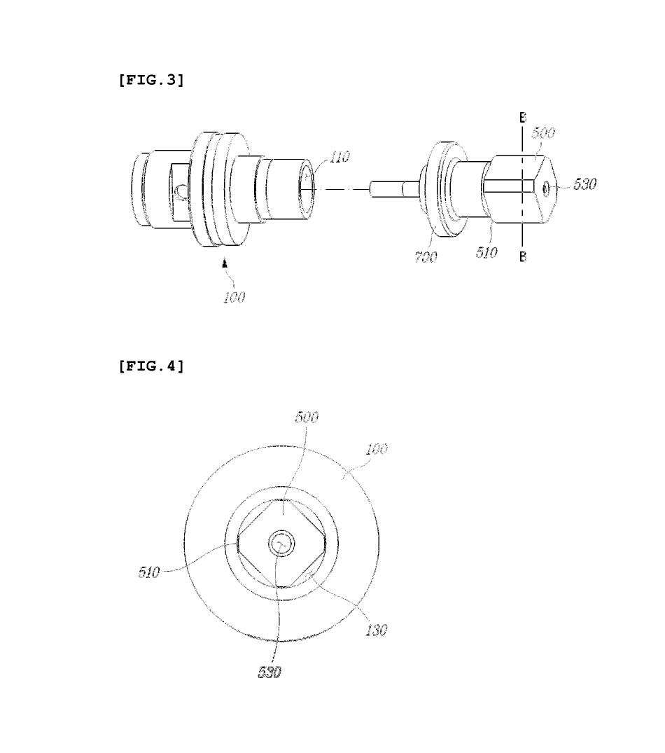

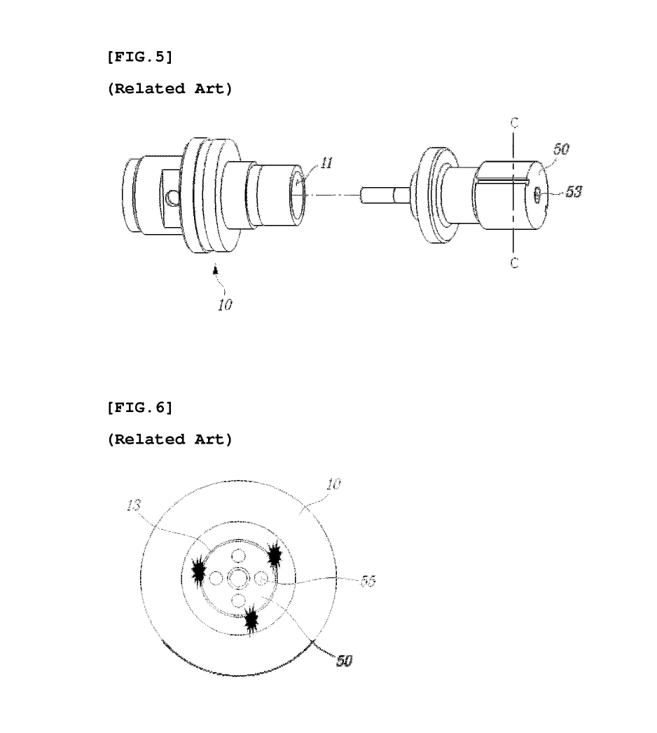

FIG. 1 is a view illustrating a high pressure pump according to an exemplary embodiment of the present inventive concept, and FIG. 2 is a cross-sectional view taken along the line A-A of FIG. 1. FIG. 3 is a view illustrating a plunger apparatus for a high pressure pump according to an exemplary embodiment of the present inventive concept, and FIG. 4 is a cross-sectional view taken along the line B-B of FIG. 3.

A plunger apparatus for a high pressure pump according to an exemplary embodiment of the present inventive concept includes a plunger 500 which has a quadrangular cross section and reciprocates in an internal passage 110 of a housing 100 to deliver a low pressure fluid to a compression chamber 300. A guide 700 is connected to the plunger 500 to guide the plunger 500 when the plunger 500 reciprocates.

When a solenoid 800 is operated by a signal of a controller (not illustrated), the plunger 500 serves to reciprocate in the internal passage 110 of the housing 100 by a magnetic field of the solenoid 800 and to open and close a valve 200 to deliver a low pressure fuel to the compression chamber 300.

In more detail, the plunger 500 has a square pillar shape and has rounded corners 510. Further, a central side of the plunger 500 is provided with a through hole 530 in a reciprocating direction. Therefore, the guide 700 penetrates through the through hole 530, and thus, the plunger 500 is guided by the guide 700 when the plunger 500 performs a reciprocating linear motion.

An inner peripheral surface of the internal passage 110 of the housing 100 has a circle shape, and the corners 510 of the plunger 500 correspond to the inner peripheral surface of the internal passage 110, such that the plunger 500 is not locked in the internal passage 110 even though the plunger 500 reciprocates in the internal passage 110. Further, unlike the existing circular plunger 50, since the plunger has the square pillar shape of which the cross section is a quadrangle, the internal passage 110 of the housing 100 linearly contacts an outer side of the plunger 500. Therefore, it is possible to prevent the plunger 500 from being stuck due to foreign materials such as tar which is a chronic problem of the plunger 500 as a friction force between the internal passage 110 and the plunger 500 is reduced.

A space 130 is formed between an outer peripheral surface of the plunger 500 and the internal passage 110, and thus a plurality of moving holes of the existing plunger for moving a fluid is not necessary. That is, according to the present disclosure, the fluid moves through the space 130, and therefore the moving holes may be removed, thereby reducing the number of molding processes of the plunger 500. In addition, only the shape of the plunger 500 is changed from the circle to the quadrangle without changing other parts, thereby preventing costs from rising and reflecting the high pressure pump structure only for Laser Doppler perfusion imaging (LDPI).

According to the plunger apparatus having the foregoing structure, unlike the existing circular plunger, the plunger has the square pillar shape of which the cross section is a quadrangle, and thus, the internal passage of the housing linearly contacts the outer side of the plunger. Therefore, it is possible to prevent the plunger from being stuck due to foreign materials such as tar which is a chronic problem of the plunger as the friction force between the internal passage and the plunger is reduced.

Further, according to the existing plunger, since the space is formed between the outer peripheral surface of the plunger and the internal passage, a plurality of moving holes are formed in the plunger for moving a fluid in the existing circular type. However, according to the exemplary embodiments of the present inventive concept, a fluid moves through the space, and therefore, the moving holes may be omitted, thereby reducing the number of molding processes for the plunger. Since only the shape of the plunger is changed from the circle to the quadrangle without other parts and configurations, costs are maintained and the high pressure pump structure only for LDPI is reflected.

Although the present inventive concept has been shown and described with respect to exemplary embodiments, it will be obvious to those skilled in the art that the present disclosure may be variously modified and altered without departing from the spirit and scope of the present disclosure as defined by the following claims.

What is claimed is:

1. A plunger apparatus for a high pressure pump, comprising:
a plunger having a quadrangular cross section and reciprocating in an internal passage provided in a housing to deliver a low pressure fluid to a compression chamber; and
a guide connected to the plunger to guide the plunger when the plunger reciprocates.

2. The plunger apparatus of claim 1, wherein the plunger has a square pillar shape.

3. The plunger apparatus of claim 1, wherein an inner peripheral surface of the internal passage has a circular shape, the plunger has rounded corners which correspond to the inner peripheral surface of the internal passage.

4. The plunger apparatus of claim 1, wherein the plunger has a through hole at the center thereof in a reciprocating direction, and the guide penetrates through the through hole to guide the plunger when the plunger reciprocates linearly.

5. The plunger apparatus of claim 1, wherein a space is formed between an outer peripheral surface of the plunger and the internal passage and the fluid moves through the space part.

6. The plunger apparatus of claim 1, wherein the plunger reciprocates in the internal passage of the housing by a magnetic field of a solenoid and opens and closes a valve to deliver the low pressure fuel to the compression chamber.
